(19) United States
(12) Patent Application Publication
(10) Pub. No.: US 2009/0127725 A1
(43) Pub. Date: May 21, 2009

(54) Intraocular Lens Molding System

(76) Inventors: Graham W. Biddle, Ontario, NY (US); Anita M. Graney, Rochester, NY (US); Daniel P. Barrows, Rochester, NY (US)

Correspondence Address: Bausch & Lomb Incorporated, One Bausch & Lomb Place, Rochester, NY, 14604-2701, US

(21) Appl. No.: 11/943,933

(22) Filed: Nov. 21, 2007

(51) Int. Cl. B29D 11/00

(52) U.S. Cl. 264/1.7; 425/588

(57) ABSTRACT

Systems and methods for making intraocular lenses (IOLs) are disclosed. The system for making an intraocular lens comprises a paddle core comprising at least a portion of a channel, and a two-cavity mold frame constructed and arranged to support the paddle core. A method of making an IOL is also provided comprising inserting the paddle core within a two-cavity mold frame, injecting a lens forming material into the two-cavity mold frame through the channel of the paddle core, and curing the lens forming material.

### BACKGROUND

1. Field of the Technology

At least one embodiment of the present invention relates generally to a system for molding intraocular lenses (IOLs). More particularly, certain embodiments relate to a molding system having components configured to improve the flow of a lens forming material to a mold cavity to make an IOL.

2. Discussion

Intraocular lenses (IOLs) have been manufactured using many different techniques including cast molding, lathing, and liquid injection molding (LIM). Using the LIM technique, a liquid lens material, for example silicone, is injected into a heated mold cavity of the desired configuration and allowed to cure and harden. In particular with regard to making a dual-element IOL, a three-piece mold is used which contains a removable paddle core. During the molding process, the paddle core occupies a volume between a first cavity block and a second cavity block. These cavity blocks and the paddle core are inserted into a two-cavity mold frame. This assembly may define two optic cavities, and in certain examples, may also define one or more haptic cavities. A system of channels is used to deliver the injection molding material to the cavities. Accomodative IOLs having two optics interconnected by one or more haptics have been disclosed in Sarfarazi in U.S. Pat. No. 6,488,708, filed Apr. 9, 1999, which is incorporated herein by reference in its entirety. While the LIM technique performs well for many reasons, certain aspects of the system for making an IOL can be improved. For example, the channel system used in the mold injection systems for making IOLs could be improved.

### BRIEF SUMMARY

Certain aspects and examples disclosed herein provide an apparatus and methods for making an intraocular lens.

In accordance with a first aspect, a system for molding a dual-element intraocular lens is provided, comprising a paddle core comprising at least a portion of a channel. The at least a portion of the channel may be a groove or indentation formed on the surface of the paddle core, or may be a conduit running through the paddle core. The system may comprise a two-cavity mold frame comprising a first cavity block forming at least a second portion of the channel, and a second cavity block constructed and arranged to support the paddle core. The first cavity block and the second cavity block form a first cavity and second cavity and the first cavity and second cavity are fluidly connected.

In accordance with an additional aspect, a method of making a dual-element intraocular lens is provided, comprising inserting a paddle core constructed and arranged to form an inwardly facing portion of an optic cavity. The paddle core also comprises at least a portion of a channel, within a two-cavity mold frame comprising a first cavity block and a second cavity block. At least one of the first and second cavity block forms the channel. The first and second optic cavities are fluidly connected. The method may also comprise injecting a lens material into the two-cavity mold frame through the at least portion of the channel of the paddle core, and curing the lens forming material.

Other advantages, novel features and objects of the invention will become apparent from the following detailed description of the invention when considered in conjunction with the accompanying drawings.

### BRIEF DESCRIPTION OF THE FIGURES

Certain illustrative examples are described below with reference to the accompanying figures in which:

FIG. 1 illustrates a perspective view of a portion of a system for molding an IOL, in accordance with certain examples;

FIG. 2 illustrates an enlarged perspective view of a portion of a system for molding an IOL, in accordance with certain examples;

FIG. 3 illustrates a perspective view of a portion of a system for molding an IOL, in accordance with certain examples;

FIG. 4 illustrates a perspective view of a portion of a system for molding an IOL, in accordance with certain examples;

FIG. 5 illustrates a perspective view of a portion of a system for molding an IOL, in accordance with certain examples;

FIG. 6 illustrates the perspective view of a portion of a system for molding an IOL as shown in FIG. 5 with a portion of the system shown in phantom, in accordance with certain examples;

FIG. 7 illustrates a cross-sectional side view of a portion of a system for molding an IOL, in accordance with certain examples; and

FIG. 8 illustrates an enlarged cross-sectional side view of a portion of the system of FIG. 7, in accordance with certain examples;

Certain features or components of the illustrative system for molding an IOL shown in the figures may have been enlarged, distorted or otherwise shown in a non-conventional manner relative to other features or components to facilitate a better understanding of the molding systems and methods disclosed herein. It will be recognized by the person of ordinary skill in the art, given the benefit of this disclosure, that the molding systems and methods disclosed herein, can be used in any orientation relative to gravity and suitable orientations will be readily selected by the person of ordinary skill in the art, given the benefit of this disclosure.

### DETAILED DESCRIPTION

Certain examples of the systems and methods disclosed herein will be recognized by the person of ordinary skill in the art, given the benefit of this disclosure to provide systems and methods for molding a dual-element intraocular lens (IOL) in a more simplified, reliable, and cost-effective manner. In particular, systems for making IOLs are provided that enhance the channel system and provide a path for the lens forming material to enter the lens cavities more directly. The systems provide an improved flow of lens forming material such that the optic and haptic cavities may be filled uniformly. The system also provides improved gate configurations to reduce damage to the product when separating the channels from the IOL. The conventional systems for injection molding IOLs may be adapted to include the present technology. It is desired to have a channel system configured to provide a more direct lens forming material pathway to the optic and haptic cavities, and improve lens edge quality during the separation of the IOL from the molding system.

As discussed above, IOLs are generally manufactured through mold injection processes. For example, IOLs may be manufactured by mold injection processes such as those described in Graney et al. in United States Patent Publication No. 2006/0069431, filed Mar. 30, 2006, which is incorporated herein by reference in its entirety. In one embodiment, a dual-element IOL may be injection molded in a mold cavity having a removable paddle core. The paddle core may comprise a mold insert. The paddle core may be made of a metal, and may be centrally located between the first and second cavity blocks of a two-cavity mold frame. The first optical element is formed between a first tool insert and a portion of the paddle core. The second optical element is formed between a second tool insert and another portion of the paddle core. Additionally, one or more haptics may connect the first and second optical elements. The one or more haptics may be integrally formed with the optical elements by the mold insert and tool inserts, and may be made of the same or different material as the optical elements. The paddle core, mold insert, and tool inserts may be assembled within a first cavity block and a second cavity block. A lens forming material, for example silicone, may be injected into the two-cavity mold frame, and allowed to cure to form some or all portions of the IOL. The lens forming material may also be selected from conventional materials such as polymethymethacrylate, glass, acrylic, or the like, provided that visual clarity, refractive ability, and biocompatibility are all maintained.

The mold injection system comprises a means for delivering a lens forming material to the mold cavities. According to aspects of the invention, the means comprises one or more channels that direct the lens forming material into the mold cavities. The channels are in fluid communication with the mold cavities. The channels may begin at a point of injection of the lens forming material from an injection device, which may be in fluid communication with a source of lens forming material. A series of channels may be used, of various shapes, sizes, and materials to obtain a smooth, unobstructed, efficient flow of lens forming material into the mold cavities. The one or more portions of the channels may reside in one or more of the components of the system. A channel of one component of the system may mate with a channel of another component of the system. The mating may allow flow-through of the lens forming material from one component to the other. Alternatively, the mating of the two channels may provide a full channel for the lens forming material to flow through (i.e., each channel that is mated is a portion of a full channel).

Once the lens forming material has been injected, the lens forming material is sent through one or more channels provided by one or more components to deliver the material to the mold cavities. The channels may be provided, for example, in core plates, upon which the cavity blocks may be mounted. The channels may also be provided between components of the system, for example, between the paddle core and a cavity block. In one embodiment, channels in the core plates, which when the mold is closed come together to form full channels, may be in fluid communication with the channels of the cavity blocks. These channels may, in turn, be in fluid communication with other channels which branch off from the channel to direct lens forming material to each of the mold cavities.

Once the lens forming material has been allowed to cure within the mold cavities, the two-cavity mold frame may then be opened and the paddle core may be removed. The IOL may then be removed from the paddle core. The mold insert may then be replaced in between the cavity blocks to injection mold another IOL. The system components are manufactured to withstand repeated molding cycles.

The present technology provides systems and methods for molding a dual-element IOL that may be manufactured by injection molding. This technology will allow for more streamlined manufacturing of IOLs. For example, this technology allows for improved flow of lens forming material through the channels and into the mold cavities. Additionally, the overall fabrication of the system is simplified which may result in reduced costs and lead times. These advantages of the present invention overcome the noted deficiencies of the current systems and methods used for making IOLs.

As used herein, the term “mate” or “mating” may describe any manner of connecting or joining two or more components together. The term “mate” or “mating” may involve any mechanical, thermal, or chemical process that connect or join two or more components together. In the embodiments disclosed herein, the term “mate” or “mating” may mean adhering, clamping, friction fitting, snapping, interlocking or otherwise connecting two components. For example, two or more components of the system may be adhered, clamped, snapped, friction fitted or interlocked together. In some embodiments, the mating may be temporary.

As used herein, the term “channel” may describe any structure that may allow a lens forming material to flow within. The channel may be a path, passage or conduit that allows the lens forming material to flow from an injection device to one or more mold cavities. The channel may be formed within one component. The channel may also be formed through the mating of two or more components. The channel may be recessed within one or more surfaces of a component. It may be of any size and shape to allow the lens forming material to flow within.

The system for molding an intraocular lens comprises a paddle core comprising at least a portion of a channel. The at least a portion of the channel may be a groove, recess, or indentation, or may be a conduit running through the paddle core. The system may also comprise a two-cavity mold frame comprising a first cavity block forming at least a second portion of the channel, and a second cavity block constructed and arranged to support the paddle core, wherein the system may form a first optic cavity and a second optic cavity that are fluidly connected

In accordance with certain embodiments, a system for molding a dual-element intraocular lens is disclosed. The system may also be used to mold an accommodative IOL. The system may comprise various components that may take part in the mold injection process. For example, the system may comprise electronic controls, heating elements for curing the intraocular lens, cooling elements, and an injection nozzle for injecting the lens forming material into the mold cavity.

In accordance with certain embodiments, the system for molding an IOL may have a component that may hold another component in place during the molding process. The component may also cooperate with other components of the system to define boundaries of the optic and haptic cavities that may form the IOL. The component may be a paddle core. The paddle core may be constructed to allow lens forming material to enter a mold cavity to form an IOL. For example, the paddle core may include at least a portion of a channel to allow lens forming material to enter a mold cavity to form an IOL. The portion of a channel may allow lens forming material to enter one or more optic cavities and/or one or more haptic cavities. The portion of a channel may be in fluid communication with one or more other portions of channels. The portion of a channel may also be in fluid communication with one or more channels. The portion of a channel may be part of a channel that leads from the position of injection of the lens forming material to the entrance of the optic cavities and/or haptic cavities. In certain examples, the portion of a channel may be recessed within the paddle core to form an indentation or groove in the paddle core. According to an aspect of the invention, by forming a channel in the paddle core, rather than just using the paddle core to define a portion of the channel, the lens forming material may reach the optic cavities and haptic cavities in a more efficient and effective manner.

The paddle core may include portions that provide part of the structure of the cavities in which injection molding material is delivered to mold an IOL. This may include portions that define the boundary of the optical elements. The portions that define the boundary of the optical elements may include portions that define the inwardly facing portion of the optical elements. For example, the paddle core may define an inwardly facing portion of the first and second optic cavities. The paddle core may also provide a first and second surface of the first and second optic cavities for the first and second optical elements. The paddle core may also include portions that define a portion of the boundary of one or more haptics. In certain examples, the paddle core may define an inwardly facing portion of the one or more haptics. The paddle core may also provide a surface of the one or more haptics. The paddle core may be made of any size or shape to provide the boundaries and surfaces mentioned above, and to allow it to be inserted into the injection molding system, and to be compatible with the other components of the system. The paddle core may be made of any material, given the benefit of this disclosure, and as discussed below in greater detail.

The paddle core may also comprise a handle to aid in placement of the paddle core within the system. More specifically, the paddle core handle may assist in the placement of it within a two-cavity mold frame. The paddle core may assist in supporting the formed IOL, and allow for easier manipulation of the formed IOL. The handle of the paddle core may also aid in transfer of the formed IOL from the mold system to remove the molded IOL.

As noted above, the paddle core may comprise at least a portion of a channel, which may deliver a lens forming material to a mold cavity of the system. The at least a portion of a channel may be in fluid communication with another portion of a channel, or another channel. The at least a portion of a channel is also in fluid communication with a mold cavity. The channel may mate with a channel of a cavity block to deliver a lens forming material to an optic cavity. For example, the channel may mate with a channel of a first cavity block to deliver the lens forming material to the first optic cavity. The channel may also mate with a channel of a cavity block to deliver the lens forming material to one or more haptic cavities. In certain embodiments, a portion of a channel of the paddle core may mate with a portion of a channel of a cavity block. In this configuration, the portions of the channel are aligned to form a full channel, as discussed above.

The paddle core may comprise more than one channel, which may deliver a lens forming material to one or more cavities. The paddle core may comprise one channel that delivers a lens forming material to an optic cavity and another channel that delivers a lens forming material to a haptic cavity. In another example, the paddle core may comprise a channel that delivers a lens forming material to a first optic cavity and another channel that delivers a lens forming material to a second optic cavity.

In accordance with certain embodiments, a two-cavity mold frame may be provided. The paddle core may reside in the two-cavity mold frame during the molding process. The two-cavity mold frame may comprise at least two components which support the paddle core. In constructions where the two-cavity mold frame comprises two components, it may comprise a first cavity block and a second cavity block. In such embodiments, the first cavity block mates with a first portion of the paddle core, and the second cavity block may mate with a second portion of the paddle core. In certain examples, the cavity blocks are mated on opposite sides of the paddle core. Tool inserts may be placed within the cavity blocks. The tool inserts may provide the outwardly facing portions of one or more of the optical elements. In certain examples, the cavity blocks may provide an outwardly facing portion of one or more haptics.

In accordance with certain embodiments, the paddle core may comprise a portion that may allow another component to be placed within. This portion of the paddle core may allow a mold insert to be supported within the paddle core. The mold insert, paddle core, tool inserts, and cavity blocks may all be assembled to form the optic and haptic cavities and associated channels for molding an IOL.

The mold insert may provide an inwardly facing surface of one or more optics of the IOL. In certain examples, the mold insert may also provide an inwardly facing surface of one or more haptics. The mold insert may mate with the paddle core by fitting it within the inner portion of the paddle core. The mold insert may be held in place by mating the two components for example, by adhering, clamping, friction fitting, or interlocking.

The mold insert may comprise one or more components. In certain examples, a first component of a mold insert may be used to define the inwardly facing portion of an anterior optic cavity. A second component of the mold insert may be used to define the inwardly facing portion of a posterior optic cavity. In other examples, a first component of a mold insert may be used to define an inwardly facing portion of a haptic. Another component of the mold insert may be used to define an inwardly facing portion of another haptic.

The mold insert may be placed in the two-cavity mold frame in conjunction with the paddle core. The paddle core may support the mold insert in the two-cavity mold frame throughout the molding process. The paddle core may also support the tool inserts in the two-cavity mold frame. Subsequent to forming a molded lens onto the mold insert, the lens and mold insert may be removed from the two-cavity mold frame along with the paddle core.

In accordance with certain embodiments, at least one of the first and second cavity blocks include at least a portion of a channel in fluid communication with the at least a portion of a channel of the paddle core. For example, the first cavity block may have a portion of a channel that is in fluid communication with a portion of a channel of the paddle core. As the paddle core and first cavity block are aligned and mated, any lens forming material injected through the portions of the channel of the cavity block, may flow through the channel of the paddle core. As mentioned above, the paddle core may be positioned between and supported by the two cavity blocks. In this assembly, the first cavity block may have a portion of a channel along a surface, which mates with the portion of a channel of the paddle core to create a channel in which the lens forming material may be delivered to a first optical element. The second cavity block may also have a channel along one surface that may align with a surface of a second cavity block having a channel along a first surface similar to that of the first cavity block. The first cavity block may define a portion of an anterior optical element. The second cavity block may define a portion of a posterior optical element.

In accordance with certain examples, the at least a portion of the channel of the paddle core may include a feature that assists in forming an edge of an IOL. Such a feature, or gate, may be in fluid communication with a channel of the system and a mold cavity and may assist in the delivering of the lens forming material to the cavities. The gate may be tapered inwardly into their respective mold cavities such that little or no gate vestige is formed at these areas of the molded IOL. The gate may be tapered inwardly, to limit the amount of formed vestige and reduce the likelihood of damaging the formed IOL, at an angle between about 5 and 45 degrees.

A channel formed at least partially by the second cavity block may also comprise a feature that assists in forming an edge of an IOL. This feature, or gate, may be positioned between the channel formed at least partially by the second cavity block and an optic cavity. As discussed above, the gate may be tapered inwardly into their respective mold cavities such that little or no gate vestige is formed at the areas of the molded IOL. The gate may be tapered inwardly, to limit the amount of formed vestige and reduce the likelihood of damaging the formed IOL, at an angle between about 5 and 25 degrees.

The components of the system may be made of any suitable material given the benefit of this disclosure that may withstand the conditions of the injection molding process. The components may be made of the same material or different, compatible materials. For example, the paddle core, and first and second cavity blocks may be made of metal. In certain examples, diamond turned metal may be used, specifically for those components that form the optical element surfaces. In other examples, the components may be made of a high quality, thermally resistant polymer material amorphous polyetherimide (e.g., ULTEM™ polymer resin).

As discussed above, the method of making a dual-element IOL may comprise inserting a paddle core constructed and arranged to form an inwardly facing portion of an optic cavity, and comprising at least a portion of a channel, within a two-cavity mold frame. The two-cavity mold frame comprises a first cavity block and a second cavity block, at least one of a first and second cavity block forming a channel, wherein the first and second optic cavities are fluidly connected. The method may also comprise injecting a lens forming material into the two-cavity mold frame through the paddle core channel, and curing the lens forming material.

Once the lens forming material has been injected, heat is applied to the system to cure the lens forming material (e.g., in the range of about 250° F. to 300° F.). In certain examples, a vacuum may be drawn to assist in the injection of the liquid lens material. Application of a vacuum during injection may be desirable to eliminate air bubble and ensure a complete fill of the mold cavities. Once the lens forming material has cured, the system is cooled.

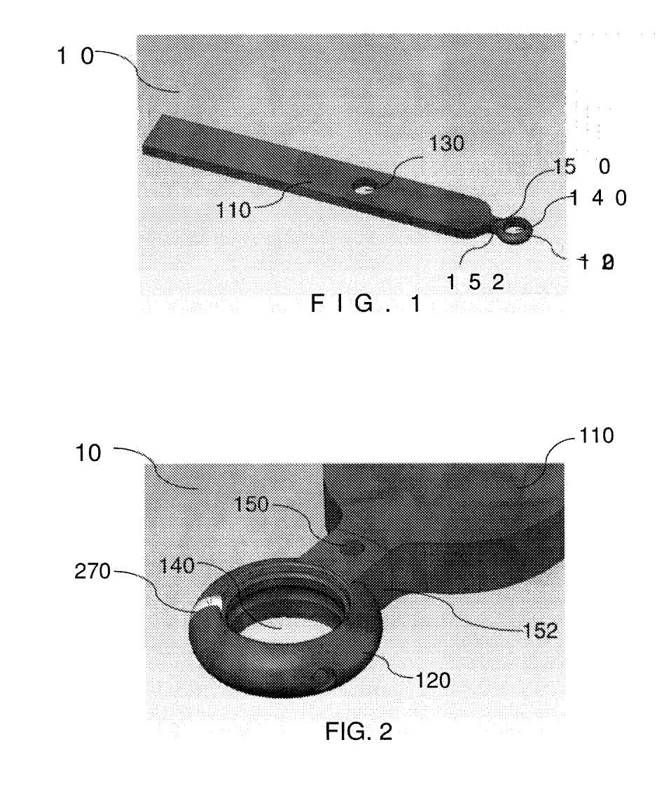

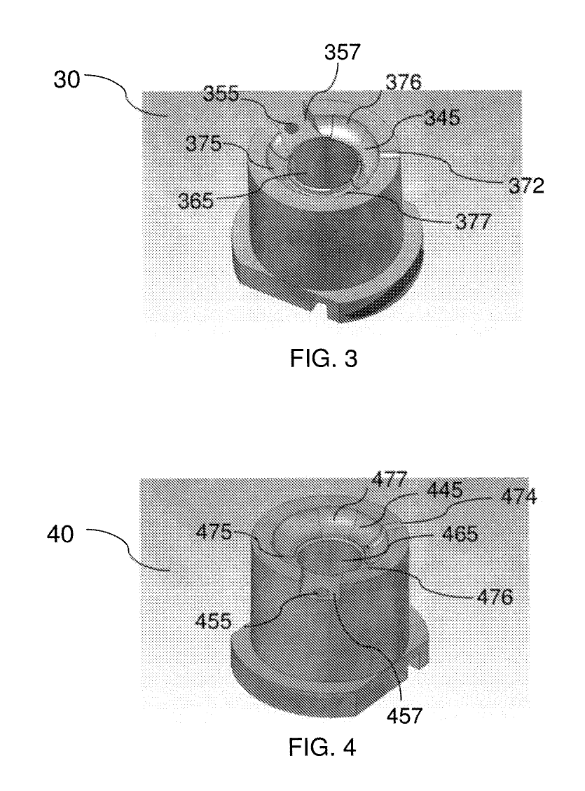

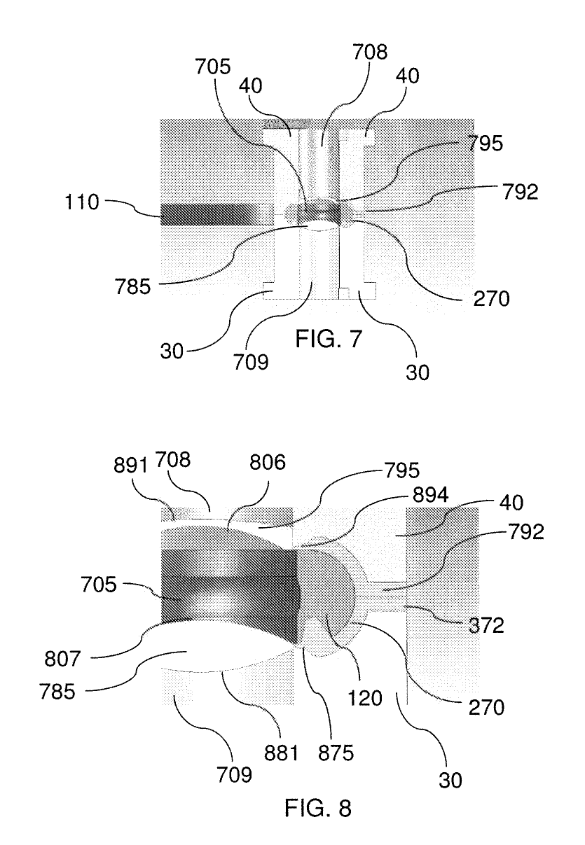

According to one embodiment, FIGS. 1 and 2 illustrate a component of the molding system. Paddle core 10 comprises handle 110, which may assist in the placement of paddle core 10 within cavity blocks 30 and 40 of FIGS. 3 and 4. Paddle core 10 comprises annular portion 120. Aperture 130 in handle 110 is engaged with a portion of cavity blocks 30 and 40 to align paddle core 10 within these cavity blocks. Mold insert 705 (shown in FIGS. 7 and 8) is placed in aperture 140 of annular portion 120, prior to placing paddle core 10 within cavity blocks 30 and 40. Mold insert 705 defines a portion of the optic cavities for molding the IOL. Aperture 150 and portion 152 may also be used to align paddle core 10 within cavity blocks 30 and 40.

FIG. 2 illustrates the position of a portion of a channel 270 of annular portion 120 of paddle core 10. Note that channel 270 forms a groove within annular portion 120. This groove or channel is aligned within cavity block 30 of FIG. 3 to provide a channel for the lens forming material to enter a cavity to form at least a portion of the IOL. Channel 270 may be any dimensions suitable for delivering the lens forming material to a cavity of the IOL.

As mentioned above, FIGS. 3 and 4 illustrate cavity blocks 30 and 40 of the molding system, which mate with annular portion 120 of FIGS. 1 and 2. FIG. 3 illustrates first cavity block 30, which may be, for example, an anterior cavity block. FIG. 3 depicts channel 372 in cavity block 30, which mates with annular portion 120 to form a channel for delivering lens forming material to the cavities. FIG. 4 illustrates second cavity block 40, which may be, for example, a posterior cavity block. FIG. 4 depicts channel 474 in cavity block 40, which mates with annular portion 120 to form a channel for delivering lens forming material to the cavities. Channel 371 and channel 474 mates to form a channel for delivering lens forming material to the cavities.

Paddle core 10 may be positioned between cavity block 30 of FIG. 3 and cavity block 40 of FIG. 4 as part of the system for making an IOL. This is accomplished by mating surfaces 345 and 445 of FIGS. 3 and 4 with annular portion 120 of paddle core 10. Additionally, alignment occurs between paddle core 10 and cavity blocks 30 and 40 by aligning portion 152 (shown in FIGS. 1 and 2) of paddle core 10 with grooves 357 and 457 of cavity blocks 30 and 40. Optic surface portion 365 forms an outwardly facing portion of a first optical element. Optic surface portion 465 forms an outwardly facing portion of a second optical element. The first optical element may be an anterior optical element, while the second optical element may be a posterior optical element.

Additionally, through alignment of the two cavity blocks, each haptic cavity is formed by mating annular portion 120 of paddle core 10 with recessed portions 375 and 475, 376 and 476, and 377 and 477 of cavity blocks 30 and 40. In this embodiment, three haptic cavities are formed to join anterior and posterior optical elements of the IOL.

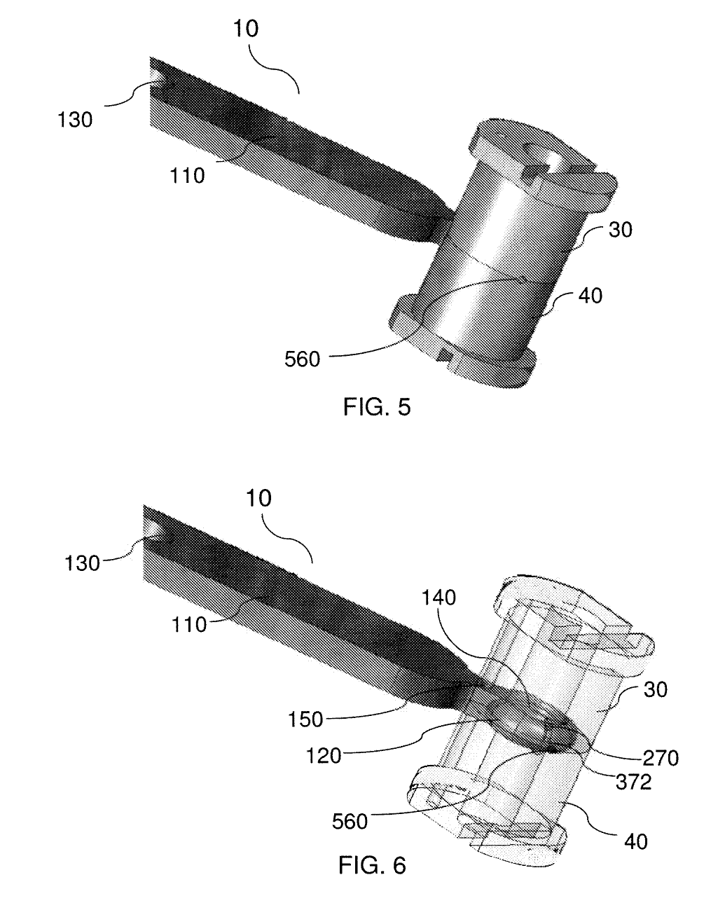

FIGS. 5 and 6 illustrate a perspective view of the paddle core and cavity block assembly. As noted above, the paddle core comprises handle 110, and annular portion 120. Aperture 130 in handle 110 is engaged with a portion of the system to align paddle core 10 within cavity blocks 30 and 40. As discussed above, mold insert 705 of FIGS. 7 and 8 is placed in aperture 140 of annular portion 120, prior to placing paddle core 10 within cavity blocks 30 and 40. Aperture 150 may be used to align paddle core 10 within cavity blocks 30 and 40. This assembly may be placed in a two-cavity mold frame prior to delivering the lens forming material into the system to make the dual-element IOL. Aperture 560 is an entrance port for the lens forming material to enter channel 270 to deliver the material to a mold cavity.

FIG. 6 illustrates cavity blocks 30 and 40 in phantom, so that annular portion 120 may be viewed. As shown, channel 270 is aligned with channel 372 of cavity block 30. The lens forming material enters channel 372 through aperture 560.

FIGS. 7 and 8 illustrate a cross-sectional view of the system as shown in FIGS. 5 and 6. Again, the system comprises a paddle core having handle 110 and annular portion 120. Optic cavity 795 is defined by surface 891 of first tool insert 708 and surface 806 of mold insert 705. Likewise, optic cavity 785 is defined by surface 881 of second tool insert 709 and surface 807 of mold insert 805. Channel 372 of cavity block 30 is in fluid communication with channel 270 of annular portion 120; channels 372 and 270 mate to form a conduit for lens forming material to flow through. Gate 875 is positioned between optic cavity 785 and channel 270 to deliver a lens forming material to optic cavity 785. Additionally, gate 894 is positioned between optic cavity 795 and channel 792 to deliver a lens forming material to optic cavity 795.

Although the molding systems and methods have been described above in terms of certain examples and embodiments, various alterations, modifications, substitutions, additions and improvements will be readily apparent to the person of ordinary skill in the art, given the benefit of the disclosure. Such alterations, modifications, substitutions, additions and improvements are intended to be within the scope and spirit of the mold injection devices and methods disclosed herein. It is also intended that the indefinite articles “a” and “an,” as used above and in the appended claims, mean one or more of the articles which they modify, and that the terms “include,” “including” and “having” are interchangeable with the open ended term “comprising.” Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for the use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific examples of the invention. It is therefore to be understood that the examples described herein are presented by way of example only and that, within the scope of the appended claims and equivalents thereto, the invention may be practiced otherwise than as specifically described.

What is claimed is:

1. A system for molding a dual-element intraocular lens, comprising:
a paddle core comprising at least a portion of a channel; and
a two-cavity mold frame comprising a first cavity block forming at least a second portion of the channel, and a second cavity block constructed and arranged to support the paddle core, the first cavity block and the second cavity block forming a portion of a first cavity and a second cavity, and the first cavity and second cavity being fluidly connected.

2. The system of claim 1, further comprising a mold insert constructed and arranged to form an inwardly facing portion of an optical element.

3. The system of claim 2, wherein the first cavity block is in fluid communication with the at least a portion of the channel.

4. The system of claim 3, wherein the at least a portion of the channel of the paddle core is constructed and arranged to be aligned with the at least a portion the channel of the first cavity block.

5. The system of claim 4, wherein the first cavity block defines a portion of an anterior optical element.

6. The system of claim 5, wherein the paddle core further comprises a gate constructed and arranged to form at least one edge of the dual-element intraocular lens.

7. The system of claim 6, wherein the gate is tapered inwardly at an angle between about 5 and 45 degrees.

8. The system of claim 3, wherein the second cavity block comprises at least a portion of a channel along a first surface and a second surface.

9. The system of claim 8, wherein the second cavity block further comprises a gate constructed and arranged to form at least one edge of the intraocular lens.

10. The system of claim 9, wherein the gate is positioned between the at least a portion of the channel of the second cavity block and an optic cavity.

11. The system of claim 10, wherein the gate is tapered inwardly at an angle of between about 5 and 25 degrees.

12. A method of making a dual-element intraocular lens comprising:
inserting a paddle core constructed and arranged to from an inwardly facing portion of an optic cavity, and comprising at least a portion of a channel, within a two-cavity mold frame comprising a first cavity block and a second cavity block, at least one of the first cavity block and second cavity block forming at least a portion of the channel, wherein the first optic cavity and second optic cavity are fluidly connected;
injecting a lens forming material through the at least portion of the channel of the paddle core; and
curing the lens forming material.

13. The method of claim 12, further comprising injecting the lens forming material into the first cavity block through a channel in fluid communication with the at least a portion of the channel of the paddle core.

14. The method of claim 13, further comprising injecting the lens forming material into the second cavity block through a channel.

15. The method of claim 12, further comprising removing the paddle core from the two-cavity mold frame.

16. The method of claim 15, further comprising removing the intraocular lens from the mold insert.
